(19) United States
(12) Patent Application Publication
(10) Pub. No.: US 2007/0092048 A1
(43) Pub. Date: Apr. 26, 2007

(54) RUNN counter phase control

(76) Inventors: Nathan P. Chelstrom, Cedar Park, TX (US); Mack W. Riley, Austin, TX (US); Shoji Sawamura, Austin, TX (US)

Correspondence Address: IBM CORPORATION (CS);C/O CARR LLP, 670 FOUNDERS SQUARE, 900 JACKSON STREET, DALLAS, TX, 75202, US

(21) Appl. No.: 11/255,155

(22) Filed: Oct. 20, 2005

(51) Int. Cl. H04L 25/38

(52) U.S. Cl. 375/369

(57) ABSTRACT

The present invention provides a data processing system, a method, and a computer program product for stopping at least two clock signals that oscillate at different frequencies and restarting the at least two clock signals at their correct phase. A RUNN counter stops the at least two clock signals. The RUNN counter stops the faster clock signal and restarts the faster clock signal at the correct phase. A phase status circuit determines the phase where the slower clock signal stopped and produces a phase status signal. A second circuit utilizes the phase status signal to start the slower clock signal at the correct phase. Therefore, the present invention insures that the faster clock signal and the slower clock signal are restarted at the correct phase. In another embodiment, the second circuit enables the present invention to start the slower clock signal at a desired phase.

### FIELD OF THE INVENTION

The present invention relates generally to a phase control mechanism for RUNN counters, and more particularly, to a synchronization mechanism that enables a user to know what phase the RUNN counter stopped and to determine which phase to restart clocks using the RUNN counter.

### DESCRIPTION OF THE RELATED ART

A RUNN counter is an on-chip device that is tied into a clocking scheme of a processor. The clocking scheme can contain multiple clock domains, wherein each clock domain oscillates at a different frequency. For example, a processor may contain a full speed clock domain and a half speed clock domain. These clock domains provide the internal clock signals for the on-chip devices. For use during processor testing, the RUNN counter controls the stopping and starting of the clock signals. Accordingly, during the debug of a processor or system on a chip, a user can utilize the RUNN counter to stop at any arbitrary clock cycle for the fastest clock in the processor or system. Then the RUNN counter restarts the fastest clock at the correct clock cycle.

FIG. 1 is a block diagram representing a multi-core processor 100 containing a RUNN counter 108. Memory control 102 manages the data storage to memory (not shown) and the data retrieval from memory for processor 100. Memory locations can include system memory, caches, and local memory. I/O control 126 manages the inputs and outputs of processor 100. For example, I/O control 126 manages the transmissions of data between the auxiliary processors 110, 112, 114, 116, 118, 120, 122, and 124. Processor complex 104 controls the maintenance functions of processor 100. Maintenance functions can include managing the clock domains and controlling the power needed by the on-chip devices.

Test control 106 manages processor 100 during testing or debugging. A user will test processor 100 during manufacturing to ensure that processor 100 works properly. A user can also accomplish periodic tests to ensure that processor 100 continues to work properly. RUNN counter 108 resides within test control 106 and controls the stopping and starting of the clock signals during testing. Processor 100 contains two synchronous clock domains; full speed clock domain 130 and half speed clock domain 128. Accordingly, full speed clock domain 130 oscillates at twice the frequency of half speed clock domain 128. Full speed clock domain 130 and half speed clock domain 128 provide the corresponding clock signals to the auxiliary processors 110, 112, 114, 116, 118, 120, 122, and 124. The specific use of the clock signals within the auxiliary processors 110, 112, 114, 116, 118, 120, 122, and 124 depends upon the function of each processor 100.

Testing or debugging programs are run on a computer software platform. Accordingly, a computer software platform manages test control 106, which controls the testing process for processor 100. One common testing computer software platform is offered through joint test action group (“JTAG”). JTAG is a computer software platform that enables testing and debugging of printed circuit boards and systems. More information on JTAG technologies can be found at wwwjtag.com. JTAG technology is commonly known in the art. A user utilizes JTAG to accomplish this type of on-chip testing.

To test or debug processor 100 a user inputs a specific number of clock cycles to indicate the stoppage of all of the clocks 128 and 130. This specific number of clock cycles represents the specific clock cycle of the fastest clock 130. For example, if a user desires to stop the fast clock 130 in 1000 cycles, then RUNN counter 108 counts down 1000 cycles for the fast clock 130 and stops all of the clocks 128 and 130 when the counter hits “0”. Stopping the clocks is necessary to enable test control 106 to test or debug processor 100 by utilizing customized clock signal patterns. Also, when the user desires to start the clock signals 128 and 130 back up after testing, RUNN counter 108 ensures the fastest clock signal 130 begins at the clock cycle where the fastest clock signal 130 was stopped.

A conventional RUNN counter 108 can cause undesired effects during this testing process. With multiple clock domains (e.g. 2 GHz and 4 GHz) RUNN counter 108 stops the clock signals 128 and 130 at the user selected clock cycle of the fastest clock signal 130. As an example, a 2 GHz clock signal is the half speed clock signal 128 and a 4 GHz clock signal is the full speed clock signal 130. FIG. 2 is a timing diagram illustrating the oscillation of full speed clock 130 and half speed clock 128. Full speed clock 130 finishes one clock cycle at time period N+1, and half speed clock 128 finishes one clock cycle at N+3. The clock cycles of half speed clock 128 are twice as long as the clock cycles for full speed clock 130.

For example, RUNN counter 108 stops full speed clock 130 at the end of a clock cycle, which could be at time N+1 or at time N+3. If RUNN counter 108 stops at time N+1 then half speed clock 128 is on the falling edge of the signal, and if RUNN counter 108 stops at time N+3 then half speed clock 128 is on the rising edge of the signal. Therefore, when clocks 128 and 130 are restarted, the testing system starts full speed clock 130 at the rising edge, but the testing system cannot identify whether half speed clock 128 should start at the falling edge (N+1) or the rising edge (N+3).

To ensure that errors are not induced from the testing or debugging process, the testing system must start both clocks 130 and 128 so that they remain in phase after the testing or debugging process. Accordingly, if the RUNN counter 108 stops at time N+1 then half speed clock 128 should restart at the falling edge of the signal, and if RUNN counter 108 stops at time N+3 then half speed clock 128 should restart at the rising edge of the signal. It is clear that a RUNN counter 108 that can control the phase of multiple clock domains after debugging or testing would provide a clear improvement over the prior art.

### SUMMARY OF THE INVENTION

The present invention provides a data processing system, a method, and a computer program product for stopping at least two clock signals that oscillate at different frequencies and restarting the at least two clocks at their correct phase. A RUNN counter stops the at least two clock signals within a processor. The RUNN counter stops the faster clock signal and restarts the faster clock signal at the correct phase. A phase status circuit determines the phase where the slower clock signal stopped and produces a phase status signal. A second circuit utilizes the phase status signal to start the slower clock signal at the correct phase. Therefore, the present invention insures that the faster clock signal and the slower clock signal are restarted at the correct phase. In another embodiment, the second circuit enables the present invention to start the slower clock signal at a desired phase.

The phase status circuit comprises a flip-flop that receives the slower clock signal and an activate signal. In response to the activate signal, the flip-flop outputs the phase status signal. The activate signal activates the flip-flop during non-testing periods and deactivates the flip-flop during testing periods. The second circuit comprises a flip-flop and a multiplexer, wherein the phase status signal is a control input signal of the multiplexer. Accordingly, the second circuit employs the phase status signal to start the slower clock signal at the correct phase.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram representing a multi-core processor containing a RUNN counter;

FIG. 2 is a timing diagram illustrating the oscillation of a full speed clock and a half speed clock in a multi-core processor;

FIG. 3 is a schematic diagram illustrating a phase status circuit which indicates a phase where a clock signal stopped;

FIG. 4 is a schematic diagram illustrating a modified RUNN counter circuit designed to start a clock signal in a correct phase;

FIG. 5 is a flow chart depicting the stop and restart of system clocks with a modified RUNN counter that utilizes a phase status circuit; and

FIG. 6 depicts a block diagram of data processing system that may be implemented, for example, as a server, client computing device, handheld device, notebook, or other types of data processing systems.

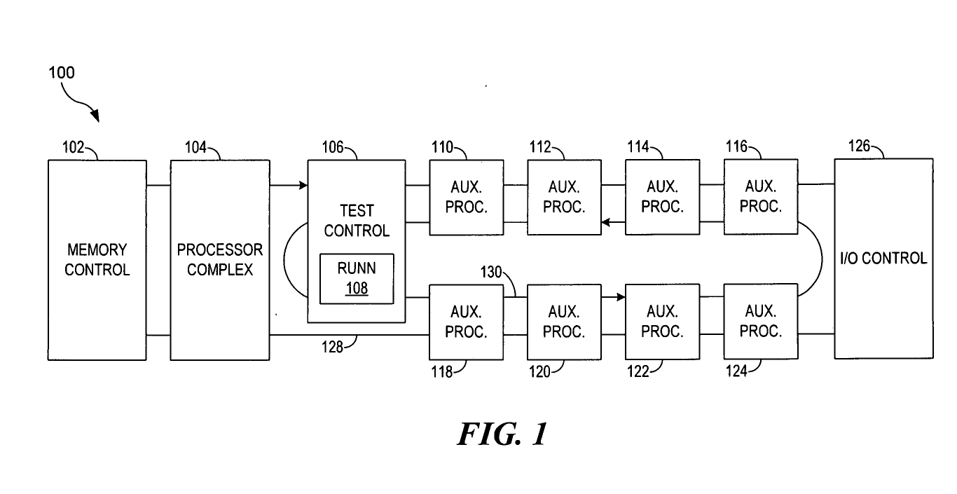

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are implemented in hardware in order to provide the most efficient implementation. Alternatively, the functions may be performed by a processor such as a computer or an electronic data processor in accordance with code such as computer program code, software, and/or integrated circuits that are coded to perform such functions, unless indicated otherwise.

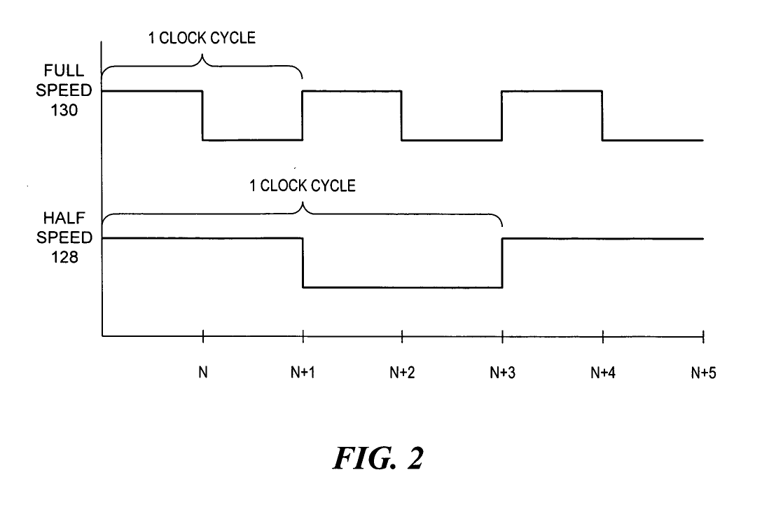

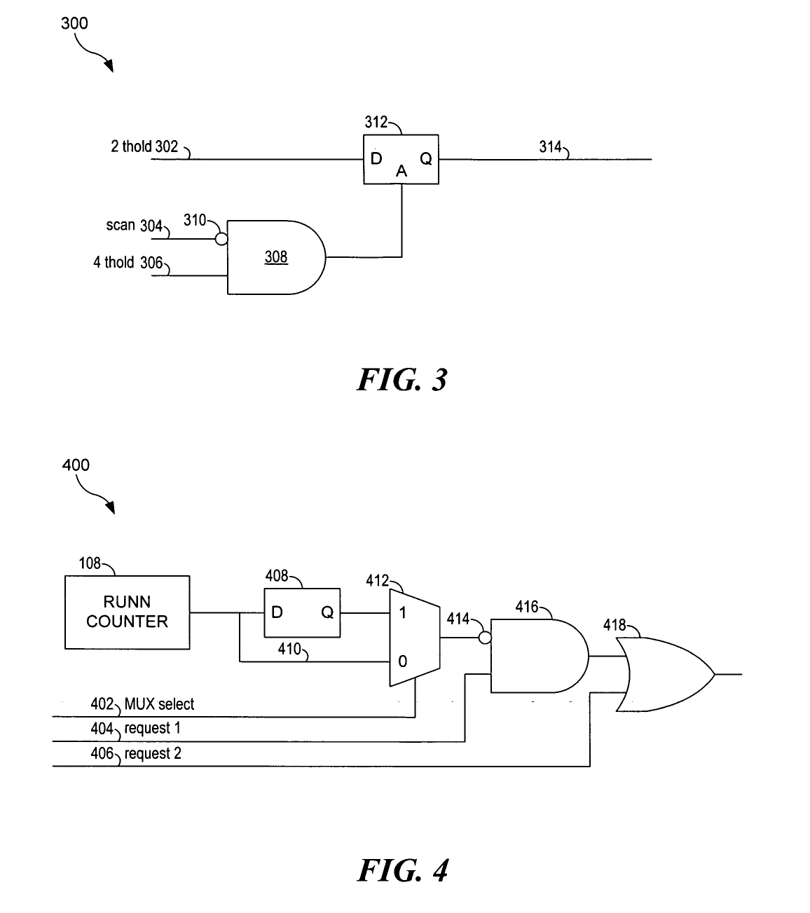

FIG. 3 is a schematic diagram illustrating a phase status circuit 300 which indicates the phase where a clock signal stopped. The 2 thold signal 302 and the 4 thold signal 306 are global signals in the clocking scheme. The 2 thold signal 302 represents a 2 GHz clock domain and the 4 thold signal 306 represents a 4 GHz clock domain. The 2 GHz clock domain represents the half speed clock domain 128 and the 4 GHz clock domain represents the full speed clock domain 130. These specific frequencies (2 GHz and 4 GHz) only represent examples of two clock domains and do not limit the present invention to these frequencies. The 2 thold signal 302 is the 2 GHz clock signal and toggles at the reference voltages (high or low). FIG. 2 shows the behavior of 2 thold signal 302 with reference to half speed clock 128. The 4 thold signal 306 remains at high reference voltage continuously and is similar to an enable signal. The scan signal 304 is at a high voltage level during scan testing and at a low voltage level during the normal function of processor 100.

An inverter or similar device 310 provides the complement of the scan signal 304 to an AND gate 308. During scan testing, AND gate 308 receives a high voltage input from the 4 thold signal 306 and a low voltage from the scan signal 304 input (due to the inverter 310). Therefore, the output of AND gate 308 is “0” or low voltage. During normal function of processor 100, AND gate 308 receives high voltage input from the 4 thold signal 306 and a high voltage from the scan signal 304 input (due to the inverter 310). Therefore, the output of AND gate 308 is “1” or high voltage. The output of AND gate 308 is the activate signal (“A”) of D flip-flop 312. A D flip-flop 312 is a common component, which is used to receive an input signal and produce an output signal representation of the input signal (with a delay) when activated. Accordingly, D flip-flop 312 is active during the normal function of processor 100 and becomes inactive at the beginning of scan testing.

D flip-flop 312 receives the 2 thold signal 302 as an input (“D”). The 2 thold signal 302 is the 2 GHz clock signal. When D flip-flop 312 is active, the output signal 314 (“Q”) toggles in the identical manner as the 2 GHz clock signal with a delay. When D flip-flop 312 is inactive the output signal 314 (“Q”) remains at the voltage level that the 2 thold signal 302 was at when D flip-flop 312 went inactive. Therefore, when D flip-flop 312 goes inactive, output signal 314 is a representation of the last voltage level of the 2 GHz clock signal. Accordingly, output signal 314 indicates the phase status (high or low voltage level) of the 2 GHz clock signal when the scan testing began. This phase status signal 314 provides JTAG with the phase status of the half speed clock 128 when RUNN counter 108 cut off the clock signals 128 and 130 for testing or debugging. Therefore, JTAG knows what phase the half speed clock 128 stopped at. JTAG then controls RUNN counter 108 to begin the half speed clock 128 in that phase after the testing.

FIG. 4 is a schematic diagram illustrating a modified RUNN counter circuit 400 designed to a clock signal in a correct phase. After the testing process is finished, RUNN counter 108 needs to start the clocks signals 128 and 130 in the correct phase. Full speed clock signal 130 always stops at either the rising edge or the falling edge of the signal, which enables RUNN counter 108 to restart the full speed clock signal 130 in the same phase after every test. RUNN counter circuit 400 utilizes phase status signal 314 to restart the half speed clock signal 128 in the correct phase. As previously stated, JTAG is the computer software platform that controls RUNN counter 108.

RUNN counter 108 begins the half speed clock signal 128 or the 2 GHz clock signal. The 2 GHz clock signal is fed into a D flip-flop 408, which is configured to produce a delay of a half clock cycle. The output of D flip-flop 408 and input line 410 are inputs to multiplexer (“MUX”) 412. The output of D flip-flop 408 (“1”) and input line 410 (“0”) represent the same 2 GHz clock signal with a half clock cycle timing difference. With reference to FIG. 2, the output of D flip-flop 408 may represent time period N+3 and the input line 410 may represent time period N+1 for the half speed clock signal 128 (2 GHz). A phase MUX select signal 402 is the control input to MUX 412. Phase MUX select signal 402 represents the phase status signal 314 of FIG. 3, which indicates the phase status of the 2 GHz clock signal when it was stopped. JTAG controls phase MUX select signal 402 to provide the correct phase. Accordingly, phase MUX select signal 402 controls MUX 412 to select the output of D flip-flop 408 or input line 410. This enables RUNN counter circuit 400 to select the correct phase of the 2 GHz clock signal when RUNN counter 108 restarts this signal.

MUX 412 transmits an output signal to inverter or similar device 414, which provides the complement of the 2 GHz signal (with a delay) to AND gate 416. A chip hold request 1 signal 404 is also an input to AND gate 416. The chip hold request 1 signal 404 comes from a test data register (“TDR”) and can stop the restart of the half speed clock signal 128. TDR (not shown) holds the data results from the tests. If chip hold request 1 signal 404 is at a low voltage level (“0”), then AND gate 416 outputs a continuous low voltage level (“0”) and not the half speed clock signal 128. If chip hold request 1 signal 404 is at a high voltage level (“1”), then AND gate 416 outputs the half speed clock signal 128. This signal 404 can stop the half speed clock 128 from being transmitted throughout processor 100. The signal from TDR 404 can hold the half speed clock signal 128 after a test in response to an error detected in the test results.

AND gate 416 transmits an output to OR gate 418. A chip hold request 2 signal 406 is an input into OR gate 418 also. If chip hold request 2 signal 406 is at a low voltage level (“0”), then OR gate 418 produces the same output from AND gate 416. If chip hold request 2 signal 406 is at a high voltage level (“1”), then OR gate 418 outputs a continuous high voltage level (“1”). This output of a continuous high voltage level (“1”) can be a request to hold the clock generators. This signal 406 holds the half speed clock 128 in multiple situations, such as an on-chip analyzer detects a problem or an external error condition involving external processors. Accordingly, if chip hold request 1 signal 404 is at a high voltage level (“1”) and chip hold request 2 signal 406 is at a low voltage level (“0”), then OR gate 418 outputs the half speed clock signal 128 in the correct phase.

Phase status circuit 300 and RUNN counter circuit 400 work in conjunction to identify the phase where the half speed clock 128 stopped and restart the half speed clock 128 in the correct phase. This ensures that the half speed clock 128 starts in the correct phase and ensures that errors are reduced in the testing process.

In another embodiment of the present invention, RUNN counter circuit 400 can start the half speed clock 128 in any desired phase. Phase MUX select signal 402 controls MUX 412, which enables JTAG to control the phase of the half speed clock signal 128. Accordingly, by controlling phase MUX select signal 402, JTAG can control the phase of the half speed clock signal 128.

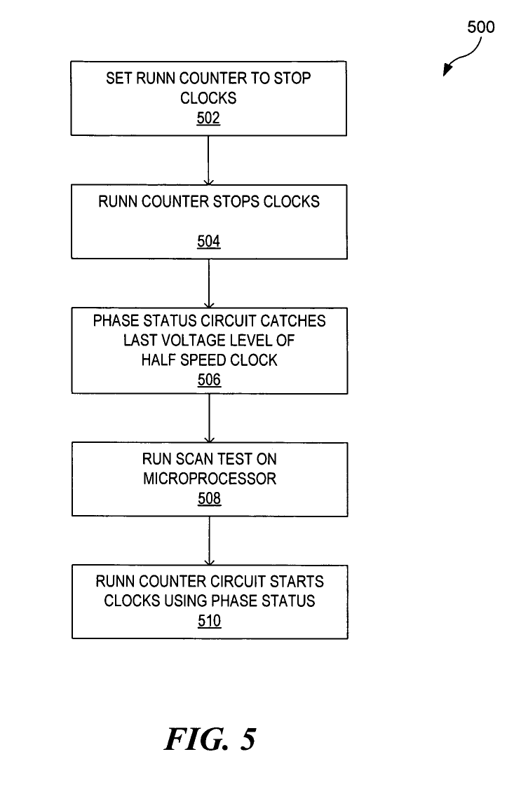

FIG. 5 is a flow chart 500 depicting the stop and restart of system clocks 128, 130 with a modified RUNN counter 108 that utilizes a phase status circuit 300. A user sets RUNN counter 108 to stop the system clocks 128, 130 after a specific amount of clock cycles 502. After this amount of clock cycles, RUNN counter 108 stops the system clocks (128, 130) 504. Phase status circuit 300 indicates the last voltage level of the half speed clock (128) 506. When. the clocks are stopped, JTAG or a similar program runs scan tests on the microprocessor 100 to ensure that it functions properly 508. Then, RUNN counter 108 starts both of the system clocks 128, 130 at the correct clock cycle 510. The phase status enables RUNN counter 108 to start the half speed clock 128 at the correct clock cycle.

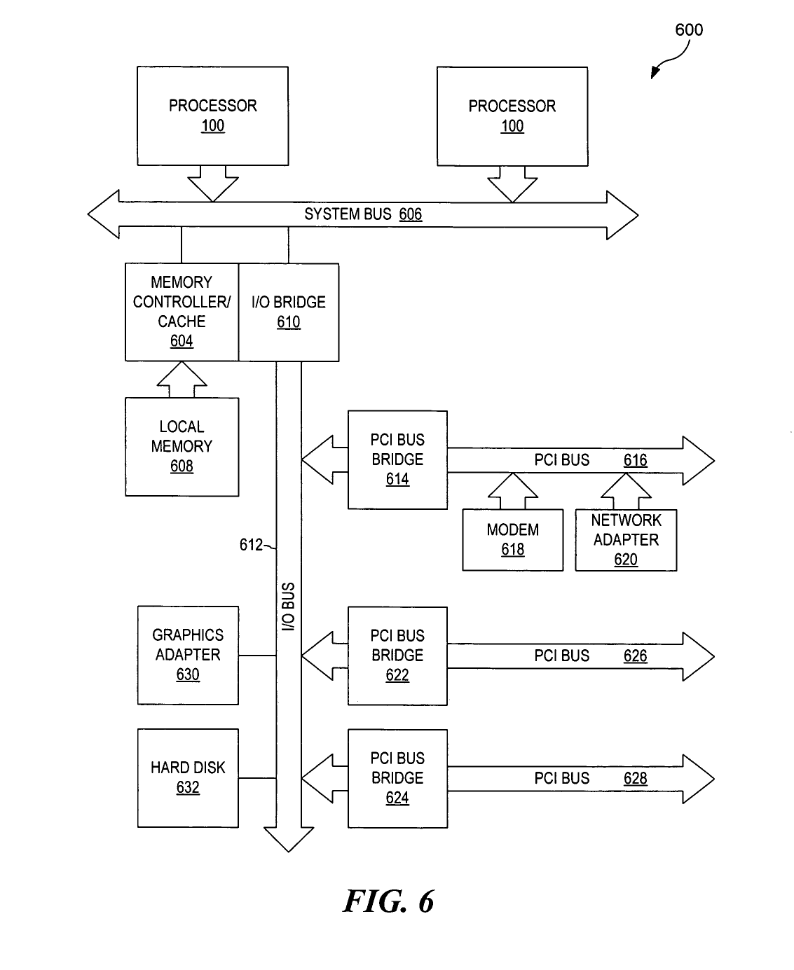

FIG. 6 depicts a block diagram of data processing system 600 that may be implemented, for example, as a server, client computing device, handheld device, notebook, or other types of data processing systems. Data processing system 600 may implement aspects of the present invention, and may be a symmetric multiprocessor (“SMP”) system or a non-homogeneous system having a plurality of processors 100 connected to the system bus 606.

Memory controller/cache 604 provides an interface to local memory 608 and connects to system bus 606. I/O Bus Bridge 610 connects to system bus 606 and provides an interface to I/O bus 612. Memory controller/cache 604 and I/O Bus Bridge 610 may be integrated as depicted. Peripheral component interconnect (“PCI”) bus bridge 614 connected to I/O bus 612 provides an interface to PCI local bus 616. A number of modems may be connected to PCI local bus 616. Typical PCI bus implementations will support four PCI expansion slots or add-in connectors. Modem 618 and network adapter 620 provide communication links to other computing devices connected to PCI local bus 616 through add-in connectors (not shown). Additional PCI bus bridges 622 and 624 provide interfaces for additional PCI local buses 626 and 628, from which additional modems or network adapters (not shown) may be supported. In this manner, data processing system 600 allows connections to multiple network computers. A memory-mapped graphics adapter 630 and hard disk 632 may also be connected to I/O bus 612 as depicted, either directly or indirectly.

Accordingly, the hardware depicted in FIG. 6 may vary. For example, other peripheral devices, such as optical disk drives and the like, also may be used in addition to or in place of the hardware depicted. The depicted example does not imply architectural limitations with respect to the present invention. For example, data processing system 600 may be, for example, an IBM Deep Blue system, CMT-5 system, products of International Business Machines Corporation in Armonk, N.Y., or other multi-core processor systems, running the Advanced Interactive Executive (“AIX”) operating system, LINUX operating system, or other operating systems.

It is understood that the present invention can take many forms and embodiments. Accordingly, several variations of the present design may be made without departing from the scope of the invention. The capabilities outlined herein allow for the possibility of a variety of networking models. This disclosure should not be read as preferring any particular networking model, but is instead directed to the underlying concepts on which these networking models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A data processing system, comprising:
at least one processor having:
at least two clock signals that oscillate at different frequencies;
at least one RUNN counter that is at least configured to stop the at least two clock signals and start one first clock signal at a correct phase;
a first circuit that is at least configured to determine a phase where at least one second clock signal stops; and
a second circuit that is at least configured to start the at least one second clock signal at a correct phase, wherein the correct phase corresponds to the phase where the at least one second clock signal stopped.

2. The system of claim 1, wherein the RUNN counter further comprises the first circuit and the second circuit.

3. The system of claim 1, wherein the first circuit further comprises at least one flip-flop, wherein the flip-flop is at least configured to:
receive the at least one second clock signal and an activate signal; and
output a phase status signal, wherein the phase status signal indicates the phase where the at least one second clock signal stops.

4. The system of claim 3, wherein the activate signal is at least configured to:
enable the flip-flop during a period of non-testing of the processor; and
disable the flip-flop during a period of testing of the processor.

5. The system of claim 3, wherein the second circuit receives the phase status signal.

6. The system of claim 5, wherein the second circuit further comprises:
at least one flip-flop; and
at least one multiplexer, wherein the phase status signal is a control input signal of the multiplexer.

7. The system of claim 1, wherein the second circuit is at least configured to start the at least one second clock signal at a desired phase.

8. A method of stopping and starting at least two clock signals that oscillate at different frequencies comprising:
setting a RUNN counter to stop the at least two clock signals;
stopping the at least two clock signals by the RUNN counter;
determining a phase where each of the at least two clock signals stopped; and
starting each of the at least two clock signals at a correct phase, wherein the correct phase corresponds to the phase where each of the at least two clock signals stopped.

9. The method of claim 8, wherein the RUNN counter is at least configured to:
determine a phase where a first clock signal stopped; and
start the first clock signal at a correct phase.

10. The method of claim 9, wherein the determining step further comprises a first circuit that is at least configured to determine a phase where a second clock signal stopped.

11. The method of claim 10, wherein the starting step further comprises a second circuit is at least configured to start the second clock signal at a correct phase.

12. The method of claim 11, wherein the first circuit outputs a phase status signal that indicates the phase where the second clock signal stopped.

13. The method of claim 12, wherein the second circuit employs the phase status signal to start the second clock signal at a correct phase.

14. The method of claim 11, wherein the second circuit is at least configured to start the second clock signal at a desired phase.

15. The method of claim 11, wherein the RUNN counter further comprises the first circuit and the second circuit.

16. A computer program product for stopping and starting at least two clock signals that oscillate at different frequencies, with the computer program product having a computer-readable medium with a computer program embodied thereon, wherein the computer program comprises:
computer program code for setting a RUNN counter to stop the at least two clock signals;
computer program code for stopping the at least two clock signals by the RUNN counter;
computer program code for determining a phase where each of the at least two clock signals stopped; and
computer program code for starting each of the at least two clock signals at a correct phase, wherein the correct phase corresponds to the phase where each of the at least two clock signals stopped.

17. The computer program product of claim 16, wherein:
computer code for enabling the RUNN counter to determine a phase where a first clock signal stopped and start the first clock signal at a correct phase;
computer code for enabling a first circuit to determine a phase where a second clock signal stopped; and
computer code for enabling a second circuit to start the second clock signal at a correct phase.

18. The computer program product of claim 17 further comprising computer code for producing a phase status signal that indicates the phase where the second clock signal stopped.

19. The computer program product of claim 17 further comprising computer code for enabling the second circuit to start the second clock signal at a desired phase.
